(19) United States
(12) Patent Application Publication
(10) Pub. No.: US 2013/0262330 A1
(43) Pub. Date: Oct. 3, 2013

(54) MANAGING OBJECTS IN A SUPPLY CHAIN USING A SECURE IDENTIFIER

(71) Applicant: SICPA HOLDING SA, Prilly (CH)

(72) Inventors: Gael SANNIER, Brent (CH); Jesper Honig SPRING, Epalinges (CH)

(73) Assignee: SICPA HOLDING SA, Prilly (CH)

(21) Appl. No.: 13/827,165

(22) Filed: Mar. 14, 2013

Related U.S. Application Data
(60) Provisional application No. 61/616,135, filed on Mar. 27, 2012.

(30) Foreign Application Priority Data
Mar. 28, 2012 (EP) 12002201.7

(51) Int. Cl. G06Q 30/00; G06Q 10/08

(52) U.S. Cl. CPC G06Q 30/0185; G06Q 10/08
USPC 705/318

(57) ABSTRACT

A system and method for authenticating an identity of an object being tracked while traversing a supply chain, which includes an interface communicating with object custodians in the supply chain using a standard protocol in which event tracking information for the object is stored when any one of the object custodians reports a predefined event for the object. The system and method also include a repository storing authentication data to authenticate the event tracking information for the object, the event tracking information including a first object identifier and a second object identifier, the second object identifier being independently authenticated from the first object identifier.

### CLAIM FOR PRIORITY

This application claims the benefit of priority to U.S. Provisional Application Ser. No. 61/616,135, filed Mar. 27, 2012, and EP Patent Application No. 12002201.7, filed Mar. 28, 2012, the entire contents of which are hereby incorporated by reference.

### BACKGROUND

1. Field of the Disclosure

The present invention generally relates to a system and method for authenticating the identity of an object being tracked while traversing in a supply chain.

2. Background Information

Supply chain management is a difficult problem for organizations that regularly conduct business in the transportation of a large number of products over a large geographic area. The ability to track and trace goods over the supply chain is difficult enough, much less the added pressures of determining or validating whether a specific good is counterfeit. Currently, systems exist in which goods may be collected and distributed in which location and status information regarding the movement of the goods is monitored throughout the supply chain. These systems use technologies such as barcodes or radio frequency identifiers (RFID) or other tagging technologies, such as global positioning satellite (GPS) technology.

RFID technology (or RFID tags) allows partners or “object custodians” (i.e. a partner in the supply chain that has custody of the product) within the supply chain to tag, identify and track products, goods, cases and pallets as they move from the manufacturing stage through the supply chain and into the hands of the buyer or consumer. As these objects move through the supply chain, wireless RFID readers communicate with the tags to collect information about the object custodian and match the acquired information to a database. Together with the electronic product code (EPC), which are stored on the RFID tags and used, for example, to identify manufacturer, product and item serial number, and electronic product code information services (EPCIS), which allows manufacturers to describe their RFID/EPC tagged products, a manufacturer may achieve greater speed and visibility into their supply chains, while increasing operational efficiency and store effectiveness. Moreover, information may be shared between trading partners.

Despite the advantages of using RFID in a supply chain system, many weaknesses remain. For example, RFID is expensive and only works when sufficient RF signal strength exists. Additionally, the presence of metal objects makes it difficult to decode the signals. Significant drawbacks to RFID include its vulnerability to hacking as well as the various implementations used by different manufacturers. That is, global standards are still being worked on. It should also be noted that some RFID devices are not designed to leave their respective network (as in the case of RFID tags used for inventory control within a company). Accordingly, this can cause problems for companies due to the proprietary nature of RFID, especially with respect to interoperability. In a world where the protection of goods and services has become increasingly important, there is a need to improve the reliability, certainty and interoperability of monitoring products in a supply chain system.

### SUMMARY OF THE DISCLOSURE

The present disclosure, through one or more of its various aspects, embodiments, and/or specific features or sub-components, provides various systems, servers, methods, media, and programs for interfacing compiled codes, such as, for example, JavaScript scripts.

In one embodiment of the disclosure, there is a global supply management system for authenticating an identity of an item being tracked while traversing a supply chain, including a plurality of standard repository systems which collect events generated by capturing information in the form of the events from a first item identifier using a standard observer device; and a plurality of secure repository systems which collect secure events generated by capturing information in the form of the secure events from an authenticator in the form of a marking using a secure observer device.

In another embodiment of the disclosure, there is a global supply management system for authenticating an identity of an item being tracked while traversing a supply chain, including a repository system which collects events generated by capturing information in the form of the events from a first item identifier using a standard observer device, and collects secure events generated by capturing information in the form of the secure events from an authenticator in the form of a marking using a secure observer device.

In still another embodiment of the disclosure, there is a system for authenticating an identity of an object being tracked while traversing a supply chain, including an interface communicating with a plurality of object custodians in the supply chain using a standard protocol in which event tracking information for the object is stored when any one of the plurality of object custodians reports a predefined event for the object; and a repository storing authentication data to authenticate the event tracking information for the object, the event tracking information including at least a first object identifier and an authenticator, wherein the authenticator is independently authenticated from the first object identifier and together forms a secure event identifiable by a secure observer device.

In yet another embodiment of the disclosure, there is a global supply management method for authenticating an identity of an item being tracked while traversing a supply chain, including collecting events in a repository system generated by capturing information in the form of the events from a first item identifier using a standard observer device, and collecting secure events generated by capturing information in the form of the secure events from an authenticator in the form of a marking using a secure observer device.

In one aspect, the disclosure further includes an event management platform to obtain supply chain visibility using the collected secure events and/or normal events to identify at least one of tampering, diversion, adulteration and counterfeiting of the item in the supply chain.

In another aspect, the plurality of standard repository systems and the plurality of secure repository systems communicate with the event management platform via a network and include a plurality of storage devices accessible by and distributed among the global supply management system.

In yet another aspect, the standard observer device is configured to capture standard information from a first object identifier, the captured information thereby forming a standard event; and the secure observer device is configured to capture the standard information from the first object identifier and secure information from the authenticator in the form of a marking, the captured information thereby forming the secure event.

In another aspect, the marking is a secure ink having intrinsic properties, the intrinsic properties including at least one of a wavelength in the range of at least one of UV, IR and Near IR, chemical composition or circular polarization. The secure observer device may also be configured to capture only the second object identifier and generate a secure event such that the secure event does not include standard event information or a standard event.

In yet another aspect, the first object identifier is linked to the authenticator. For example, when the first object identifier is a barcode, the authenticator can be printed in any number of fashions as well known in the art. The authenticator may also include part of the information of the first object identifier or associated or linked in a specified manner.

In another aspect, the secure observer device captures the standard information and the secure information, the secure event is sent to at least one of the plurality of secure repository systems, and when the standard observer device captures the standard information, a standard event is sent to at least one of the plurality of standard repository systems. The standard information and the secure information may also be linked. Additionally, the standard repository and secure repository systems may be linked.

In still another aspect, the item is one of a box, box comprised of a plurality of items and an aggregation of boxes.

In yet another aspect, the standard repository system stores the standard events linked to the item during a life cycle of the item in the supply chain, the standard event in the form of data representative of the first object identifier.

In one other aspect, the first item identifier is one of a bar code, RFID and a conventional data matrix that is transformed into a standard event when read by the standard observer device.

In another aspect, the standard and secure observer devices are one of a scanner and a mobile device, which may be static or semi-static.

In still another aspect, the secure repository system stores the standard event and the secure event which are linked to the item during a life cycle of the item in the supply chain, the standard event in the form of data representative of the first object identifier and the secure event in the form of data representative of the authenticator.

In yet another aspect, the standard event and the secure even are captured simultaneously by the secure observer device.

In another aspect, the item is marked with the first object identifier and the authenticator.

In still another aspect, the plurality of standard repository systems and the plurality of secure repository systems together comprise a single repository system.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 is an exemplary system for use in accordance with the embodiments described herein.

FIG. 2 discloses an exemplary event tracking system using an object identifier in accordance with the instant system.

FIG. 3 illustrates an exemplary serialization platform in which items and articles are marked with an object identifier.

FIG. 4 illustrates an exemplary system of code generation and securitization in accordance with the disclosure.

FIG. 5 illustrates and exemplary supply chain network.

FIG. 6 illustrates an exemplary system whereby an event tracking system and serialization platform are integrated.

FIG. 7A illustrates an exemplary flow diagram of coding and tagging an object in accordance with the system.

FIG. 7B illustrates an exemplary flow diagram of event tracking and authentication in accordance with the system.

FIG. 8 illustrates an exemplary block diagram of generating a secure event in accordance with the system.

FIG. 9 illustrates an exemplary global repository in accordance with the system.

### DETAILED DESCRIPTION

The present disclosure, through one or more of its various aspects, embodiments and/or specific features or sub-components, is thus intended to bring out one or more of the advantages as specifically noted below.

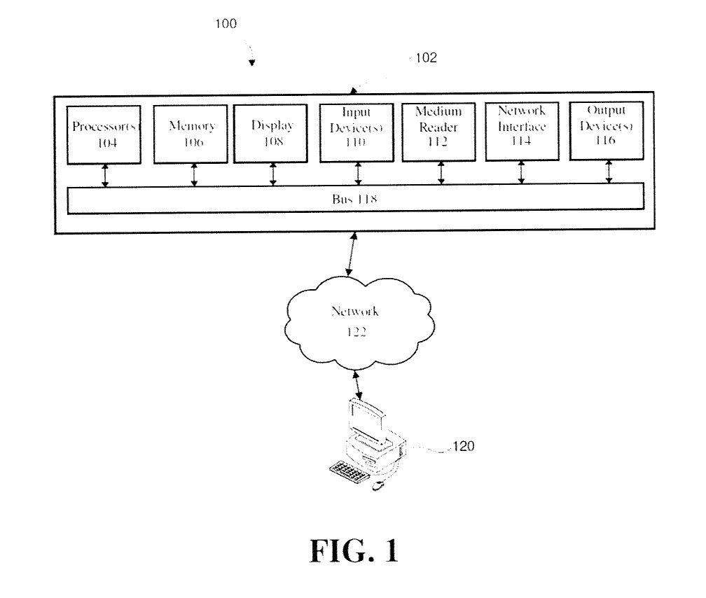

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, additional embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display. The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

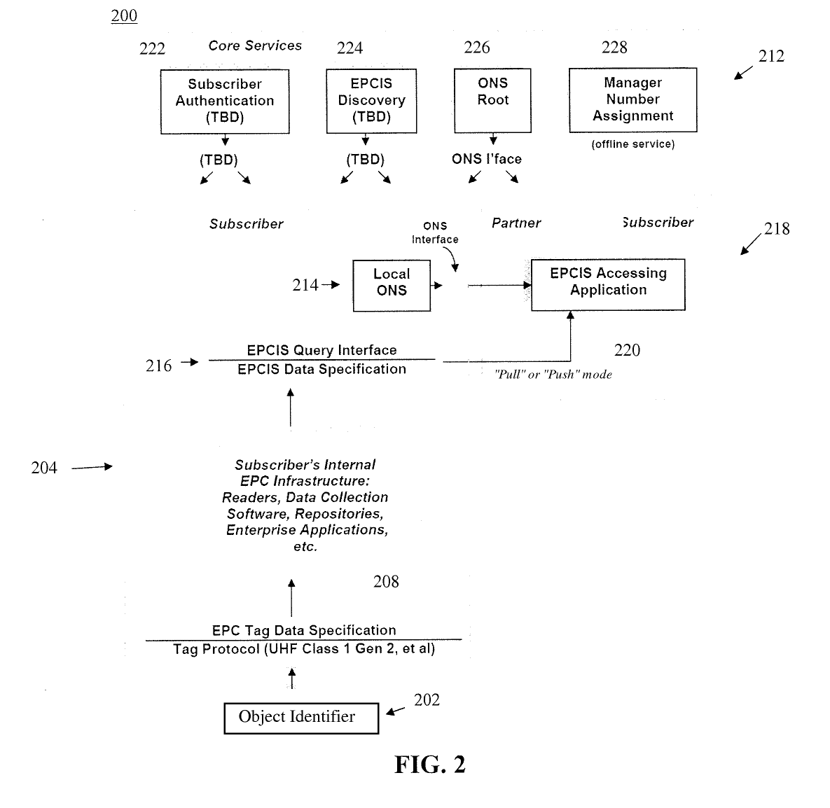

FIG. 2 discloses an exemplary event tracking system using an object identifier in accordance with the instant system. The system 200 includes, but is not limited to, core services 212 such as subscriber authentication 222, EPCIS discovery 224, ONS (Object Name Service) Root 226 and manager number assignment 228; subscriber system 204 such as a subscriber's internal EPC infrastructure 208, standard EPCIS query interface and data specification 216 and a local ONS and ONS interface 214; and partner subscriber system 218 such as EPCIS accessing application 220. The subscriber internal EPC infrastructure includes, for example, readers, data collection software, repositories, enterprise applications, etc. Also shown is object identifier 202, such as an authenticator that is used to mark and identify goods and products along the supply chain, as described in more detail below. The query interface 216 is standardized to enable track and trace, product authentication and diversion detection across various partner subscribers across the supply chain. Partner subscribers maintain their own data, with events being posted and distributed with the other partners as needed.

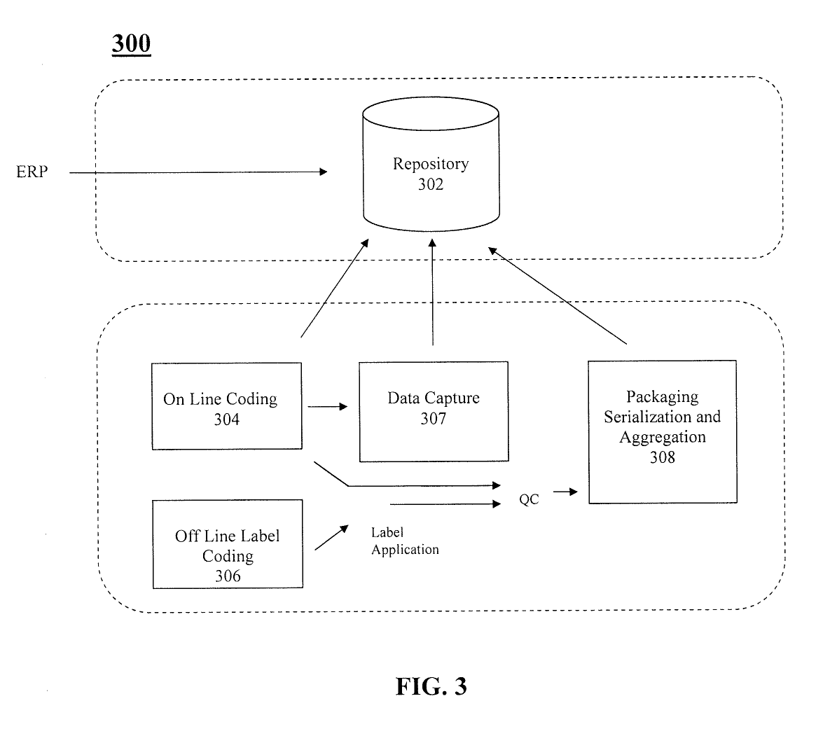

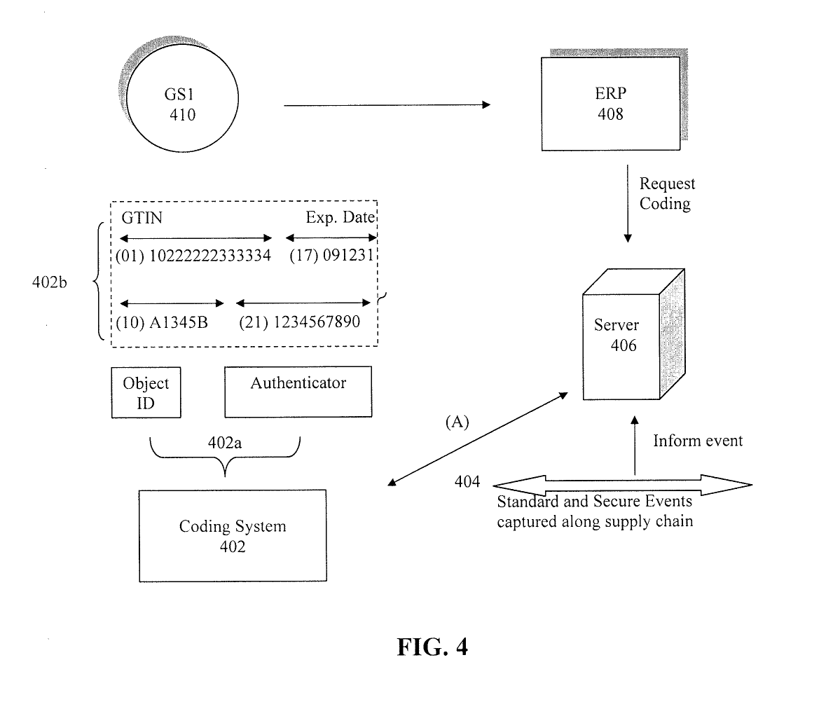

With the exemplary system illustrated in FIG. 2, items and articles (e.g. “objects”) such as value documents, banknotes, passports, identity documents, driving licenses, official permissions, access documents, stamps, tax stamps and banderoles, transportation tickets, event tickets, labels, foils, packaging which contains pharmaceuticals, food, cigarettes, cosmetics products, spare parts and consumer goods may be marked—either directly (i.e. applied to surface (on-line)) or indirectly (i.e. applied to a label and then attached to surface (off-line)). For example, FIG. 3 illustrates an exemplary serialization platform in which items and articles are marked with an object identifier 202 (shown in FIG. 2). As illustrated, the serialization platform 300 includes, for example, an on-line coding system 304 and/or an off-line label coding system 306. The on-line coding system 304 enables digital coding, data control and capture, such as a camera; and product recognition and identification. The off-line label coding system 306 provides coding machines that may be installed in secure centers, at converters, internal or contracted packers, or the like, and include various packaging forms such as rolls, sheets, boxes, etc. Moreover, a label (or seal applicator, tax stamp, a sleeve, etc. not necessarily laminated to the label) are provided, as well as a secure supply chain management form coding facilities to production plants. These on-line and off-line coding systems generate a code, as explained with reference to FIG. 4. The generated coding is captured (on-line coding) or applied (off-line coding) at 307, quality control is performed and the objects are packaged with individual serial numbers including links to the individual objects contained therein (308). Multiple products may also be packaged into a single container with the products linked to the contained in a parent-child relationship. The equipment designed to perform serialization is, for example, GS1 compliant, versatile, available for any material shape and substrate, ready for on-line and off-line coding and capture, compatible with existing environments, GMP compliant and tunable to specific authenticating features when required. Captured data for each item is stored in repository 302, as well as the aggregated and serialized packaging information 308. The repository may also be accessible, for example, by third-parties via an enterprise resource planning (ERP) system.

The coding method itself is used to mark an object with an object identifier, such that the object has traceability and visibility in the supply chain, and is standard compliant. Moreover, the employed coding method enables standard or commercial equipment (without authentication) to be used to read or scan the object identifier, while introducing the ability to observe (trace and track) an object with an added layer of security (i.e. authentication) by virtue of the object identifier. A method for marking an item or article includes, for example, providing an item or article to be marked, and applying at least one authenticator or object ID in the form of a marking, such as polymeric liquid crystal material or specific security ink with specific luminescent properties or chemical composition or circular polarization in the form of indicia, pattern or specific symbology representing a unique code by a variable information printing process onto the object as the object identifier, also known as a secure ink. The secure ink may have intrinsic properties, the intrinsic properties including at least one of a wavelength in the range of UV and/or IR and/or Near IR, chemical composition or circular polarization. In particular, the unique code represented by the indicia, pattern or specific symbology may be encrypted information, and the method may include encrypting the information. The liquid crystal precursor composition or specific security ink with specific luminescent properties or chemical composition can be applied to a substrate by any coating or printing technique. Preferably the composition is applied by a variable information printing process, such as laser printing or ink-jet printing of the continuous or of the drop-on-demand type, spraying techniques could also be present. It is appreciated that the disclosure is not limited to the described embodiments and that any method readily understood to the skilled artisan may be used to mark an item or article with an authenticator.

FIG. 4 illustrates an exemplary system of code generation and securitization in accordance with the disclosure. The system 400 includes, for example, coding system 402, which generates a secure object identifier or authenticator in the form of a marking 402a (an exemplary annotation of which appears at 402b), a supply chain 404 having partners which capture events of an object as it traverses the supply chain, a server 406 which provides event management and a secure repository for storing secure event information, an ERP system 408 to integrate management information across the system and a global standards organization 410, such as GS1, that provides a global trade item number (GTIN). More specifically, the coding 402a (also referred to herein as event tracking information) is generated to provide the system with the ability to track and trace a product along the supply chain 404. The coding 402a includes, but is not limited to, the GTIN, expiration date, lot number and a secure serial number, as illustrated by annotated code 402b. A secure object identifier is generated using the coding system 402 by supplying the server 406 with partial coding information (e.g. GTIN, expiration date and lot number) and appending information relating to the authenticator. Together, the partial coding information and authenticator information form a secure object identifier 402a. The secure object identifier 402a is identifiable using a variety of reading devices which remains specific according to the nature of the marking. For example, the reading device for reading the secure object identifier may be constructed using commercially available barcode readers, such as hand-held CCD/CMOS-camera reading equipment and reading stations used in the retail industry or any form of scanner readily understood by the skilled artisan. However, such a commercially available device, while capable of reading the partial coding information (e.g. GTIN, expiration date, lot number), will not be able to read the authenticator information without a further adapted or enabled device (e.g. a secure data capture device or a secure observer device), as explained below. In other embodiments, mobile phone authentication and SMS authentication services may be used to capture data.

In one embodiment, the object identifier (e.g. code) includes a first object identifier and a second object identifier or authenticator, where the first object identifier 402b includes partial coding information (such as GTIN, expiration date and lot number) and the second object identifier or authenticator in the form of a marking that conveys information that is different from the first object identifier information. That is, the second object identifier or authenticator information includes a separate identifier that is used to authenticate objects. As stated above, commercially available reading devices will not be able to read the secure information. In order to read the second object identifier, and thereby be able to verify and authenticate the corresponding object(s), the reading device is further adapted or independently created to read the second object identifier information or authenticator (e.g. authenticator information in the form of a marking). More specifically, the reading device is not only enabled to read the object identifier, but also to authenticate it since it is capable of reading authenticator in the form of a marking on the object. The secure object identifier or authenticator in the form of a marking is read from the device is matched with information stored in the server 406 and corresponding to the object (i.e. product) marked with the object identifier and authenticator. Alternatively, the information read by the reading device may be matched with information stored in the reading device itself or exchanged between the reading device and an external data base. The exchange of information can occur in encrypted form, using any technique known to the skilled artisan, and may be exchanged using any known technique, whether by wire or wirelessly. Without authorized access to the enabled or adapted reading device, the added security, verification and authentication is not possible. Moreover, it is appreciated that while the disclosed embodiment refers to two object identifiers (first and second object identifier), the disclosure is not limited to such an embodiment. Any number of object identifiers and/or authenticators may be incorporated into the coding for any number of reasons. Moreover, the second object identifier or authenticator is not limited to a marking, but be presented as any form of indicia pattern or specific symbology that can be used to secure and authenticate an object, as appreciated in the art. The second object can be also fused with the first object identifier, e.g. a data matrix or a barcode which code for an information able to generate the standard events but printed with a secure ink as above described able when read by the secure observer to generate the secure events.

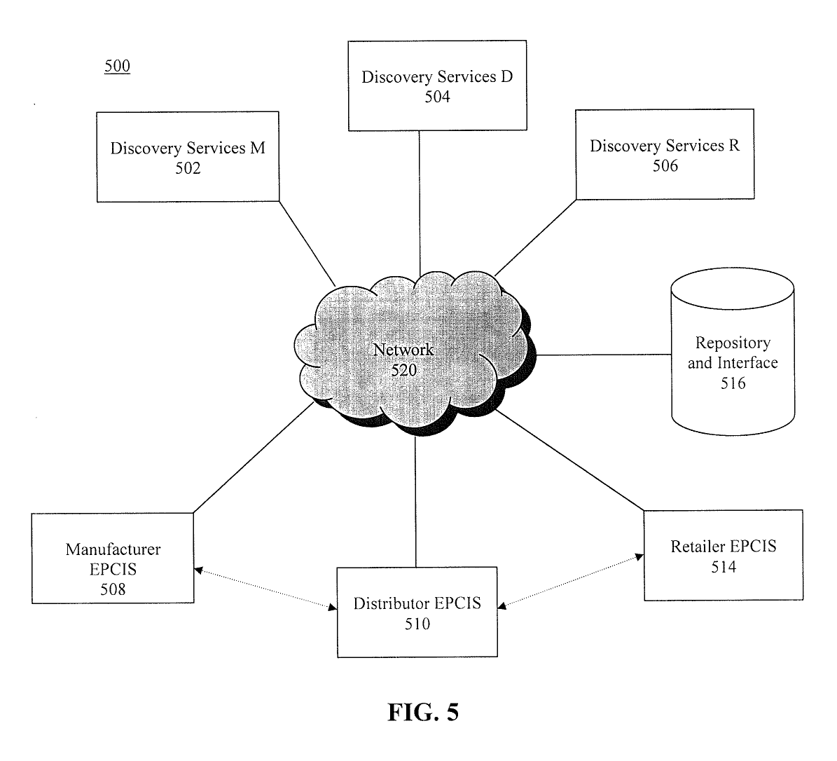

FIG. 5 illustrates an exemplary supply chain network. The system 500 includes, for example, manufacturers 508, distributors 510, retailers 514, a repository and interface 516 and discovery services 502, 504 and 506 over which the different components of the system 500 communicate through a network 520, such as the Internet. The discovery services 502, 504 and 506 include a database (and interfaces) to promote data exchange by offering a service that links information about objects (items) as they move, for example, through a supply chain from a manufacturer 508, to a distributor 510 and to a retailer 514. As an item passes through the supply chain and is registered by data capture devices at each of the custodians 508, 510 and 514 (as described above), captured data in the form of standard or secure events are sent to the appropriate discovery service. This allows trading partners to find other partners along the supply chain who had possession of a given object and to share events about that object.

The network 520 can be a public or private network, such as the Internet, and the communication over this network can be done through any conventional wired or wireless means. The discovery services are exposed to the network 520, to be accessed by any computer or device accessible on the network. However, access must be authorized by an authoritative party in order for the discovery services 502, 504, 506 to be used. Authorized companies may register EPCs and EPCIS URL links when they manufacture or receive a new item. Additionally, authorized companies can retrieve links to all EPCISs that contain events for a specific EPC. In some implementations the discovery services store records with the following attributes: an EPC number of the item, a URL or pointer to the EPCIS that submitted this record to indicate that it had custody of the item, a certificate of the company whose EPCIS submitted this record, a visibility flag indicating whether the record can be shared with anybody, or only with parties who submitted records about the same EPC, that is, supply chain partners, and a timestamp of when the record was inserted. Essentially, the discovery services are a registry of every EPCIS that has information about instances of a certain object (or GTIN of an object). As a product moves along the supply chain, it may pass through the fields of view of many different trading partners (e.g. manufacturer 508, distributor 510, retailer 514, etc.), each of which may record an observable event about the product (object). Each EPCIS instance is then registered with the discovery service that services that partner in the supply chain. When track and trace information is required for an object, the discovery service provides a list of the EPCIS instances that contain information. In addition to the EPC information, as explained above, the track and trace information also provides independent or secure event information which is enabled by the object identifier (and specifically, the second object identifier as described above).

More specifically, each object and/or packaging which contains the object or objects being tracked along the supply chain and includes an object identifier and authenticator. As explained, a data capture device (reading device) may be used to scan an object identifier and authenticator when one of several events occurs. These events may include, but are not limited to, shipment, receipt, placement into storage, removal from storage, loading into a conveyance, unloading from conveyance, etc. For example, when an object is sent from a distributor to a retailer, a reader device at the first distributor indicates that the object is leaving and this information is forwarded to a corresponding discovery service, and when the object reaches the retailer, another reader device indicates the object has arrived and this information is stored in a corresponding discovery service. An added layer of protection and security is provided using the repository and interface 516, which, as described, stores an object identifier and authenticator that is linked or associated with a corresponding product. The object identifier and authenticator provide an added level of security because only a reader device (data capture device) that is specifically designed to read the object identifier and authenticator can verify a corresponding product on which it is placed. This added level of security greatly reduces the likelihood of counterfeit goods entering the supply chain.

A brief explanation of the process involving the various entities of FIG. 5 is described. The process starts, for example, with an item passing through a supply chain, from the manufacturer 508 through the distributor 510 to the retailer 514. Custody of the item is registered along the supply chain with the manufacturer's, distributor's and retailer's discovery service (which may be the same or different services). In some embodiments, the registration occurs when an event is captured about the object. That is, when a specified event occurs, the event associated with the object is posted to the discovery service. This information is also reported and stored in repository and interface 514. The repository and interface 514 can validate the authenticity of the object based on the object identifier and authenticator information having been previously captured and stored during the coding process.

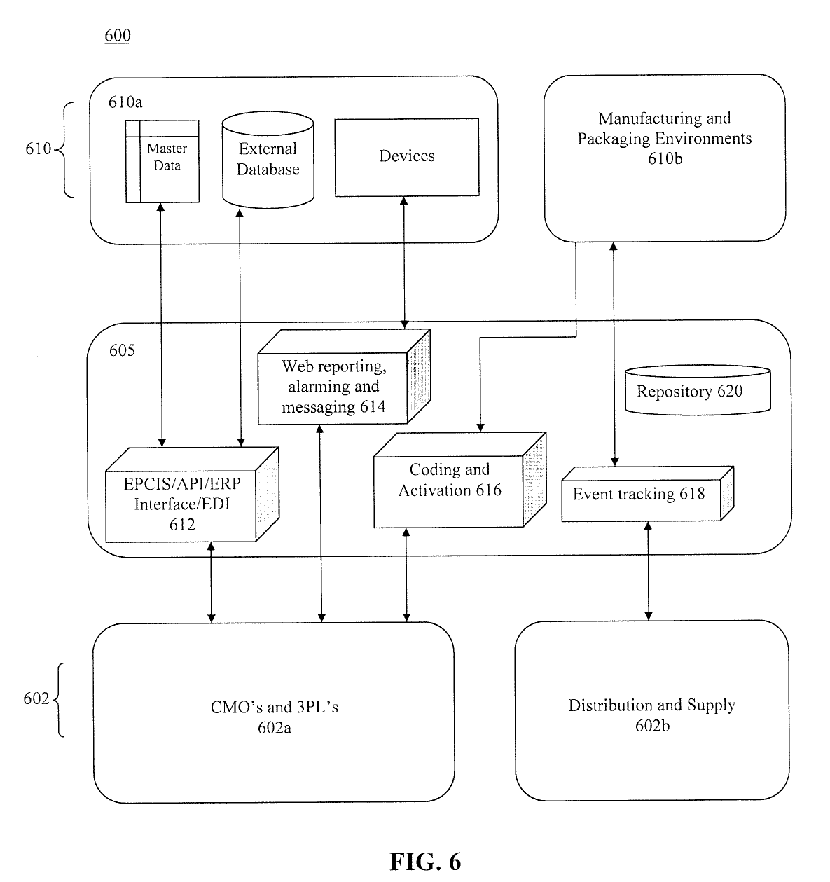

FIG. 6 illustrates an exemplary system whereby an event tracking system and serialization platform are integrated. The system 600 includes, for example, third party services 602, such as CMO's and 3PL's 602a and distribution and supply 602b; an interface and serialization platform 605, including for example EPCIS query services, interfaces and electronic data interchange services 612, reporting and messaging services 614, coding and activation 616, event tracking 618 and repository 620; and back-end systems 610 including master data and legacy database information 610a and manufacturing and packaging environments 610b. More specifically, the interface and serialization platform 605 is responsible for interfacing between third parties 602a and 602b and the back-end system 610, as well as store data and information related, for example, to coding and activation and event tracking. Additionally, the interface and serialization platform 605 is responsible for providing event reporting (such as web reporting, alarms and messaging when specified events occur in the supply chain), and coordinating with the ERP master data and external and legacy databases 610a, as well as the manufacturing and packaging services 610b. The platform 605 thereby processes a variety of functions to ensure control, integrity, visibility and operational efficiencies. Further, the platform 605 allows tracking and tracing of an object with or without authentication of secure events. In addition to the aforementioned event reporting, the system allows for product documentation and transaction association, geographical localization, document management, exception management and chain of custody alerts.

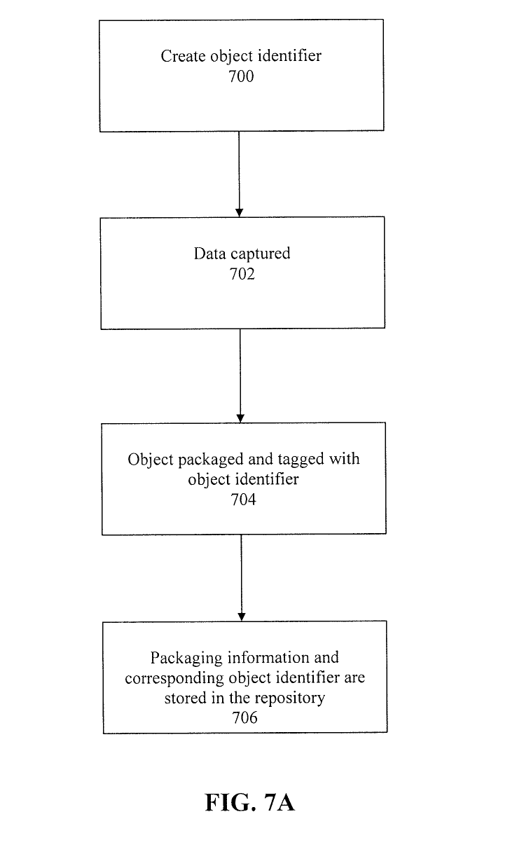

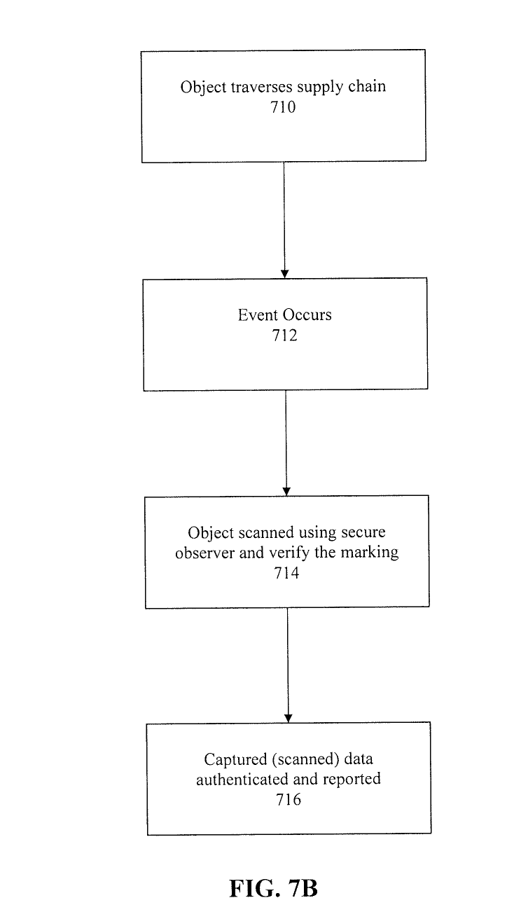

FIG. 7A illustrates an exemplary flow diagram of coding and tagging an object in accordance with the system. At 700, an object identifier is created using the techniques described above. The object identifier is captured in a repository of information at 702, and the object is packaged and tagged with the object identifier at 704. At 706, packaging information and the corresponding object identifier are stored together in the repository and associated for later use, for example to later authenticate the object as it traverses a supply chain. FIG. 7B illustrates an exemplary flow diagram of event tracking and authentication in accordance with the system. At 710, an object travels along a supply chain, making several stops at various partners. At each of the partners, when a specified event occurs (712), the object is scanned with a data capture device. The data capture device, as explained, reads the object identifier at 714 and the respective partner reports the captured information for later authentication at 716. Commercially available or non-secure data capture devices (i.e. a device not capable of reading a secure event (as defined below)) read the object marking such that the event verification does not include authentication using the secure object identifier or authenticator. A secure data capture device, on the other hand, is an authenticated and dedicated device that reads the object marking such that the secure object identifier or authenticator of the object can be read and used to validate and authenticate the object along the supply chain. Reading and authenticating an object when an event occurs in this regard is termed a secure event. That is, the event having caused the track and trace information to be posted to the system is “secure” by virtue of the fact that the data capture device is able to read, identify and verify that the secure object identifier or authenticator is properly associated with the object. For example, the secure object identifier or authenticator may be a secure ink that is read and linked to the event.

An example of the process described in FIGS. 7A and 7B is now described. The supply chain includes three partners, a manufacturer, a distributor and a retailer (as illustrated, for example, in FIG. 5). The manufacturer posts an event to the discovery server that indicates a product will be placed into the supply chain and that an order has been received. When the manufacturer has completed manufacturing the product, the product is tagged with an object identifier and authenticator is scanned. The object identifier and authenticator corresponding to the product(s) is stored in a repository, and another event is created and posted to the discovery server indicating that the product has been completed and is being transferred to the distributor. Once received at the distributor, the product is scanned by a secure observer device to verify and authenticate the product using the object identifier and authenticator, and the distributor passes the product along to the wholesaler. Another event is posted to the discovery server indicating that the distributor has shipped the product to a wholesaler. Once received at the retailer, a further event is posted to the discovery server indicating that the product has been received, and once again the product may be verified and authenticated along the supply chain by scanning the object identifier and authenticator using a secure observer device. It is appreciated that each partner along the supply chain records all relevant data along with the tacking event information when posted to the discovery server, thereby allowing downstream partners to have a view of the product as it traverses the supply chain.

The events posted and stored in the discovery server, which may be the same or different discovery servers, are viewable by the partners in the supply chain using known techniques such as a database of events, queues and logging tables. Events may be formed in a wide variety of classes depending on the product traversing the supply chain. Notification and messages may also be provided to partners using web reporting, sending alarm notifications and sending messages via email, SMS, MMS or using any other means known to the skilled artisan. When a partner wishes to authenticate and verify a product, a query can be made to the system via the serialization and interface platform 605, discussed hereinabove. In addition to typical information such as event type, event date, partner name, etc., the partner may also request or automatically have delivered information regarding the authenticity of the product (assuming a secure observer device is used to read the object identifier and authenticator). In this regard, the product may be matched against information stored in the serialization and interface platform 605. If it is determined that a match has been found, then the product may be verified, as described above.

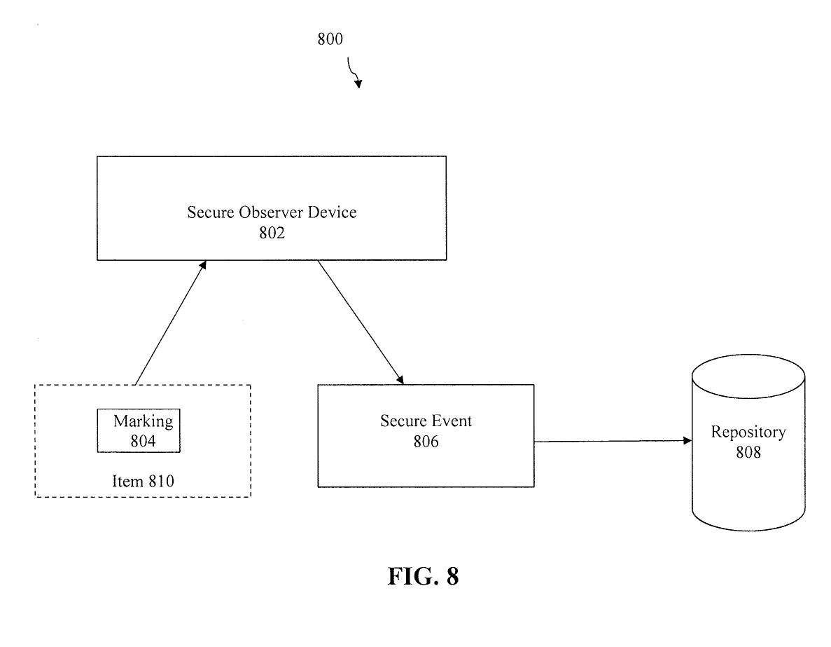

FIG. 8 illustrates an exemplary block diagram of generating a secure event in accordance with the system. The exemplary secure event system 800 includes various components, for example, a secure observer device 802, an item 810 with marking 804, a secure event 806 and a repository 808. The various components may be linked together via wired or wireless communication and may be the part of the same or different networks (not illustrated). As an item traverses a supply chain, the secure observer device captures data about the item. The captured data includes standard event information and secure event information. The captured data forms a secure event 806 which is transmitted to repository 808 for storage. Although the disclosed embodiment describes storage of the secure event 806 in repository 808, the disclosure is not limited to such an embodiment. Rather, the secure event 806 could be stored in the secure observer device 802, or in any other location accessible on the network.

The marking 804 on item 810 includes standard event information and secure event information. In one embodiment, the marking 804 includes both the standard and secure event information. In another embodiment, the standard event information is separate from the secure event information. A secure event 806 is any combination of data in which the secure event information is present. For example, a first object identifier identifies the standard event information, and an authenticator or second object identifier (in the form of the marking) identifies the secure event information. It is appreciated, however, that the disclosure is not limited to the described embodiment, which are exemplary in nature. The marking 804 may be a secure ink, watermark or specific symbology (such as a cloud of dots visible and/or invisible with specific meaning) or any other form of secure identifier that may be read by the secure observer device (secure data capture device). The secure observer device 802 authenticates the marking 804 and adds a signature or encryption to the captured data and stores it as a secure event 806 in the repository 808.

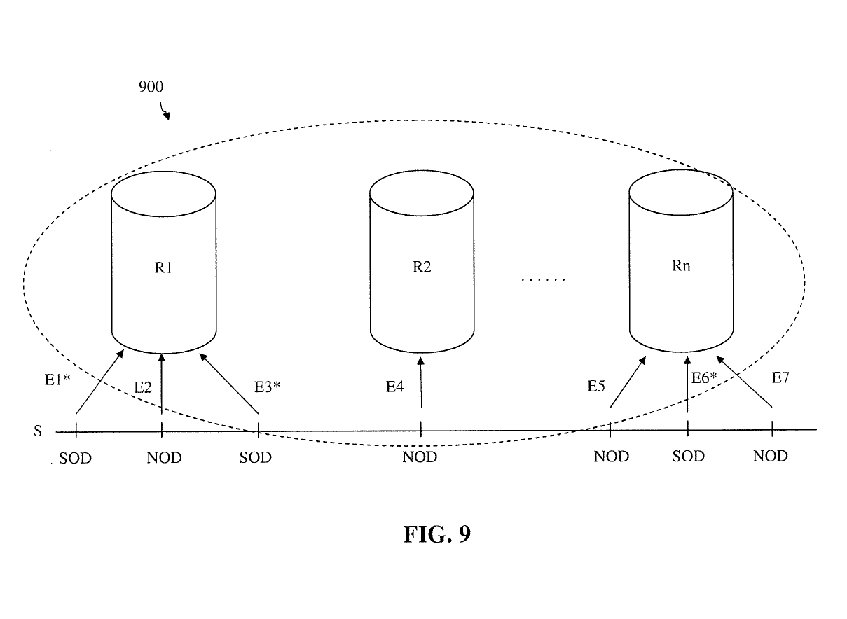

FIG. 9 illustrates an exemplary global repository in accordance with the system. The global repository 900 includes, for example, repository R1, repository R2 and repository Rn. The repositories R1, R2 and Rn may be located in the same or different networks and may be associated with the same or different custodians along a supply chain S. In the illustrated example, several events occur as an item travels across supply chain S. An event in the exemplary embodiment is represented by the alpha-numeric En, where n is an integer representing the event number. In this case, a total of seven events (E1-E7) are illustrated. Events En with an asterisk (“*”) represent a secure event and events without an asterisk represent a standard or non-secure event. As described above, a standard event is generated when a standard data capture device (normal observer device NOD) reads standard event information identified on an item in the supply chain S. A secure event, on the other hand, is generated when a secure data capture device (secure observer device SOD) reads standard event information and secure event information on an item in the supply chain S, which information is authenticated by the secure observer device SOD. In the illustrated embodiment, repository R1 receives secure events E1* and E3* captured from a secure observer device SOD, and a standard event E2 captured from a normal observer device NOD. Repository R2 receives a standard event E4 captured by a normal observer device NOD, and repository Rn receives secure event E6*, captured by a secure observer device SOD, and standard events E5 and E7, captured by a normal observer device NOD.

Significantly, the ability to authenticate an object using a secure data capture device improves the ability to detect counterfeit and/or adulterated objects at a specific location in the supply chain. That is, in the management system of the instant disclosure, authentication detection can occur at a specific location since secure events are based on a reading of an object identifier or authenticator and since different secure data capture devices can create different secure events based on the object identifier or authenticator. In traditional management systems, using for example EPCIS and RFID technology, the counterfeit and/or adulterated goods could not be detected at a specific location in the supply chain, not even identified as occurring at some location between two points (i.e. two data capture device points) in the supply chain. This is because the event captured in the traditional system, as explained above, is a standard or non-secure event in which an added level of authentication does not occur. Using the global supply management system of the instant disclosure, it is possible to retrieve the location of the adulteration and/or counterfeiting in a faster manner than in traditional management systems thanks to the added level of authentication of the global supply management system of the instant disclosure. Indeed, the search for the location of the adulteration and/or counterfeiting can be tremendously accelerated, since it can be limited to the portion of the supply chain located between the secure data capture device, where the authentication of the tracked item failed, and the immediately preceding secure data capture device in the supply chain (i.e between two data capture SOD points).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory.

Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

According to another aspect of the invention, a system for authenticating an identity of an object being tracked while traversing a supply chain comprises:

an interface communicating with a plurality of object custodians in the supply chain using a standard protocol in which event tracking information for the object is stored when any one of the plurality of object custodians reports a predefined event for the object; and

a repository storing authentication data to authenticate the event tracking information for the object, the event tracking information including at least a first object identifier and an authenticator, wherein

the authenticator is independently authenticated from the first object identifier and together form a secure event identifiable by a secure observer device.

According to another aspect of the invention, when the predefined event is reported, the event tracking information includes at least a first set of event information and a second set of event information, the second set of event information including a confirmation of authentication of the authenticator.

According to another aspect of the invention, the first object identifier is linked to the authenticator.

According to another aspect of the invention, the system further includes a server to verify a chain of custody of the plurality of object custodians by tracking and tracing the object without authentication.

According to another aspect of the invention, the event tracking information is stored in a database.

According to another aspect of the invention, the object is marked with the first object identifier and the authenticator.

According to another aspect of the invention, the first object identifier is readable without authentication.

According to another aspect of the invention, the authenticator is at least one of a security ink, watermark and symbology scanned by a dedicated authentication data capture device.

According to another aspect of the invention, the data capture device is linked to an electronic product code information service.

According to another aspect of the invention, the data capture device validates the scanned object when the data capture device is verified to be at a location consistent with information stored in the repository.

According to another aspect of the invention, the repository includes a plurality of storage devices accessible by and distributed among the system.

According to another aspect of the invention, the system provides an automated message when a predefined event is reported by one of the object custodians in the supply chain.

According to another aspect of the invention, the predefined event is defined as at least one of creating, receiving, distributing, terminating and voiding the object.

According to another aspect of the invention, the object is contained within a package, and the object and package are associated with one another for linking event tracking information stored in the repository.

According to another aspect of the invention, the system further comprises secure checkpoints in the supply chain that identify the secure event captured by the secure observer device.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A global supply management system for authenticating an identity of an item being tracked while traversing a supply chain, comprising:
a repository system which collects events generated by capturing information in the form of the events from a first item identifier using a standard observer device, and collects secure events generated by capturing information in the form of the secure events from an authenticator in the form of a marking using a secure observer device.

2. The global supply management system according to claim 1, further comprising an event management platform to obtain supply chain visibility using the collected secure events to identify at least one of tampering, diversion, adulteration and counterfeiting of the item in the supply chain.

3. The global supply management system according to claim 2, wherein the repository system communicates with the event management platform via a network and includes a plurality of storage devices accessible by and distributed among the global supply management system.

4. The global supply management system according to claim 1, wherein
the standard observer device is configured to capture standard information from a first object identifier, the captured information thereby forming a standard event; and
the secure observer device is configured to capture the standard information from the first object identifier and secure information from the authenticator, the captured information thereby forming the secure event.

5. The global supply management system according to claim 4, wherein the marking is a secure ink having intrinsic properties, the intrinsic properties including at least one of a wavelength in the range of at least one of UV, IR and Near IR, chemical composition or circular polarization.

6. The global supply management system according to claim 4, wherein the first object identifier is linked to the authenticator.

7. The global supply management system according to claim 4, wherein
when the secure observer device captures the standard information and the secure information, the secure event is sent to the repository system, and
when the standard observer device captures the standard information, a standard event is sent to the repository system.

8. The global supply management system according to claim 4, wherein the item is one of a box, box comprised of a plurality of items and an aggregation of boxes.

9. The global supply management system according to claim 4, wherein the repository system stores the standard events linked to the item during a life cycle of the item in the supply chain, the standard event in the form of data representative of the first object identifier.

10. The global supply management system according to claim 9, wherein the first item identifier is at least one of a bar code, RFID and data matrix able to generate a standard event when read by the standard observer device.

11. The global supply management system according to claim 9, wherein the standard and secure observer devices are one of a scanner and a mobile device.

12. The global supply management system according to claim 4, wherein the repository system stores the standard event and the secure event which are linked to the item during a life cycle of the item in the supply chain, the standard event in the form of data representative of the first object identifier and the secure event in the form of data representative of the marking.

13. The global supply management system according to claim 12, wherein the standard event and the secure event are captured simultaneously by the secure observer device.

14. The global management system according to claim 8, wherein the item is marked with the first object identifier and the authenticator.

15. A global supply management system for authenticating an identity of an item being tracked while traversing a supply chain, comprising:
a plurality of standard repository systems which collect events generated by capturing information in the form of the events from a first item identifier using a standard observer device; and
a plurality of secure repository systems which collect secure events generated by capturing information in the form of the secure events from an authenticator in the form of a marking using a secure observer device.

16. The global supply management system according to claim 15, further comprising an event management platform to obtain supply chain visibility using the collected secure events to identify at least one of tampering, diversion, adulteration and counterfeiting of the item in the supply chain.

17. The global supply management system according to claim 16, wherein the plurality of standard repository systems and the plurality of secure repository systems communicate with the event management platform via a network and include a plurality of storage devices accessible by and distributed among the global supply management system.

18. The global supply management system according to claim 15, wherein
the standard observer device is configured to capture standard information from a first object identifier, the captured information thereby forming a standard event; and
the secure observer device is configured to capture the standard information from the first object identifier and secure information from the authenticator, the captured information thereby forming the secure event.

19. The global supply management system according to claim 18, wherein the marking is a secure ink having intrinsic properties, the intrinsic properties including at least one of a wavelength in the range of at least one of UV, IR and Near IR, chemical composition or circular polarization.

20. The global supply management system according to claim 4, wherein the first object identifier is linked to the authenticator.

21. The global supply management system according to claim 18, wherein
when the secure observer device captures the standard information and the secure information, the secure event is sent to at least one of the plurality of secure repository systems, and
when the standard observer device captures the standard information, a standard event is sent to at least one of the plurality of standard repository systems.

22. The global supply management system according to claim 21, wherein the item is one of a box, box comprised of a plurality of items and an aggregation of boxes.

23. The global supply management system according to claim 18, wherein the standard repository system stores the standard events linked to the item during a life cycle of the item in the supply chain, the standard event in the form of data representative of the first object identifier.

24. The global supply management system according to claim 23, wherein the first item identifier is one of a bar code, RFID and data matrix that is transformed into a standard event when read by a standard observer device.

25. The global supply management system according to claim 23, wherein the standard and secure observer devices are one of a scanner and a mobile device.

26. The global supply management system according to claim 18, wherein the secure repository system stores the standard event and the secure event which are linked to the item during a life cycle of the item in the supply chain, the standard event in the form of data representative of the first object identifier and the secure event in the form of data representative of the authenticator.

27. The global supply management system according to claim 26, wherein the standard event and the secure event are captured simultaneously by the secure observer device.

28. The global management system according to claim 22, wherein the item is marked with the first object identifier and the authenticator.

29. The global management system according to claim 15, wherein the plurality of standard repository systems and the plurality of secure repository systems together comprise a single repository system.

30. A system for authenticating an identity of an object being tracked while traversing a supply chain, comprising:
an interface communicating with a plurality of object custodians in the supply chain using a standard protocol in which event tracking information for the object is stored when any one of the plurality of object custodians reports a predefined event for the object; and
a repository storing authentication data to authenticate the event tracking information for the object, the event tracking information including at least a first object identifier and an authenticator, wherein
the authenticator is independently authenticated from the first object identifier and together form a secure event identifiable by a secure observer device.

31. The system according to claim 30, wherein when the predefined event is reported, the event tracking information includes at least a first set of event information and a second set of event information, the second set of event information including a confirmation of authentication of the authenticator.

32. The system according to claim 30, wherein the first object identifier is linked to the authenticator.

33. The system according to claim 30, further including a server to verify a chain of custody of the plurality of object custodians by tracking and tracing the object without authentication.

34. The system according to claim 30, the event tracking information is stored in a database.

35. The system according to claim 30, the object is marked with the first object identifier and the authenticator.

36. The system according to claim 30, the first object identifier is readable without authentication.

37. The system according to claim 30, the authenticator is at least one of a security ink, watermark and symbology scanned by a dedicated authentication data capture device.

38. The system according to claim 37, wherein the data capture device is linked to an electronic product code information service.

39. The system according to claim 38, wherein the data capture device validates the scanned object when the data capture device is verified to be at a location consistent with information stored in the repository.

40. The system according to claim 30, the repository includes a plurality of storage devices accessible by and distributed among the system.

41. The system according to claim 30, the system provides an automated message when a predefined event is reported by one of the object custodians in the supply chain.

42. The system according to claim 30, the predefined event is defined as at least one of creating, receiving, distributing, terminating and voiding the object.

43. The system according to claim 30, wherein the object is contained within a package, and the object and package are associated with one another for linking event tracking information stored in the repository.

44. The system according to claim 30, further comprising secure checkpoints in the supply chain that identify the secure event captured by the secure observer device.

45. A global supply management method for authenticating an identity of an item being tracked while traversing a supply chain, comprising:
collecting events in a repository system generated by capturing information in the form of the events from a first item identifier using a standard observer device, and collecting secure events generated by capturing information in the form of the secure events from an authenticator in the form of a marking using a secure observer device.

46. The global supply management method according to claim 45, further comprising obtaining supply chain visibility in an event management platform using the collected secure events to identify at least one of tampering, diversion, adulteration and counterfeiting of the item in the supply chain.

47. The global supply management method according to claim 46, wherein the repository system communicates with the event management platform via a network and includes a plurality of storage devices accessible by and distributed among the global supply management system.

48. The global supply management method according to claim 45, wherein
the standard observer device is configured to capture standard information from a first object identifier, the captured information thereby forming a standard event; and
the secure observer device is configured to capture the standard information from the first object identifier and secure information from the authenticator, the captured information thereby forming the secure event.

49. The global supply management method according to claim 48, wherein the marking is a secure ink having intrinsic properties, the intrinsic properties including at least one of a wavelength in the range of at least one of UV, IR and Near IR, chemical composition or circular polarization.

50. The global supply management method according to claim 48, wherein the first object identifier is linked to the authenticator.

51. The global supply management method according to claim 48, wherein
when the secure observer device captures the standard information and the secure information, the secure event is sent to the repository system, and
when the standard observer device captures the standard information, a standard event is sent to the repository system.

52. The global supply management method according to claim 48, wherein the item is one of a box, box comprised of a plurality of items and an aggregation of boxes.

53. The global supply management method according to claim 48, wherein the repository system stores the standard events linked to the item during a life cycle of the item in the supply chain, the standard event in the form of data representative of the first object identifier.

54. The global supply management method according to claim 53, wherein the first item identifier is one of a bar code, RFID and data matrix that is transformed into a standard event when read by the standard observer device.

55. The global supply management method according to claim 53, wherein the standard and secure observer devices are one of a scanner and a mobile device.

56. The global supply management method according to claim 48, wherein the repository system stores the standard event and the secure event which are linked to the item during a life cycle of the item in the supply chain, the standard event in the form of data representative of the first object identifier and the secure event in the form of data representative of the marking.

57. The global supply management method according to claim 56, wherein the standard event and the secure even are captured simultaneously by the secure observer device.

58. The global management method according to claim 51, wherein the item is marked with the first object identifier and the authenticator.
